(19) United States
(12) Patent Application Publication
(10) Pub. No.: US 2026/0224083 A1
(43) Pub. Date: Aug. 6, 2026

(54) ROBOT CLEANER AND CONTROLLING METHOD OF THE SAME

(71) Applicant: LG ELECTRONICS INC., Seoul (KR)

(72) Inventors: Janghun CHEONG, Seoul (KR); Sungbeom CHO, Seoul (KR); Yongmin SHIN, Seoul (KR); Woochan JUN, Seoul (KR); Jinwoo HAN, Seoul (KR); Yeonghyun KIM, Seoul (KR)

(73) Assignee: LG ELECTRONICS INC., Seoul (KR)

(21) Appl. No.: 19/529,983

(22) Filed: Feb. 4, 2026

(30) Foreign Application Priority Data
Feb. 4, 2025 (KR) 10-2025-0013805

(51) Int. Cl. A47L 11/30

(52) U.S. Cl. CPC A47L 11/305; A47L 2201/06

(57) ABSTRACT

Embodiments of the present disclosure provide a robot cleaner including a body accommodating a battery and at least one motor therein, a driving unit configured to move the body, and a wet cleaning unit disposed at a rear side of the driving unit and configured to wipe a floor surface. When liquid is present on the floor surface, the body is configured to travel backward toward a position where the liquid is present to wipe while collecting the liquid. The robot cleaner provides an effect of preventing the liquid from spreading to surroundings.

This application claims priority to and the benefit of Korean Patent Application No. 10-2025-0013805 filed on February 04, 2025, the disclosure of which is incorporated herein by reference in its entirety.

### BACKGROUND

### Technical Field

Embodiments of the present disclosure relate to a robot cleaner and a method for controlling the same, and more particularly, to a robot cleaner and a method for controlling the same for cleaning a floor by wiping liquid spilled on the floor.

### Background of the Disclosure

A cleaner is a device that performs a cleaning operation by suctioning or wiping dust or foreign substances from a target cleaning area.

Such cleaners may be classified into manual cleaners, in which a user directly moves the cleaner to perform cleaning, and autonomous cleaners, which perform cleaning while traveling by themselves.

Here, a robot cleaner suctions foreign substances such as dust from a floor while autonomously traveling within an area to be cleaned. In addition, the robot cleaner may automatically travel and clean the cleaning area using obstacle sensors or other sensors provided therein, or may be controlled to travel and clean manually using a remote control wirelessly connected to the robot cleaner.

### SUMMARY

The present disclosure has been made to improve the problems of the conventional robot cleaner and the method for controlling the same as described above. An object of the present disclosure is to provide a robot cleaner and a method for controlling the same that, when liquid is spilled on a floor surface, wipe the liquid so as to prevent the liquid from spreading to surroundings during a cleaning process.

Additionally, an object of the present disclosure is to provide a robot cleaner and a method for controlling the same that can prevent the floor surface from being contaminated as the robot cleaner travels due to the liquid getting on wheels.

To achieve the object as described above, a robot cleaner according to the present disclosure includes: a body accommodating a battery and at least one motor therein; a driving unit configured to move the body; and a wet cleaning unit disposed at a rear side of the driving unit and configured to wipe a floor surface, wherein, when liquid is present on the floor surface, the body travels backward toward a position where the liquid is present.

In this case, the body may travel forward away from the position where the liquid is present.

In addition, the body may clean the floor surface by repeatedly traveling backward and forward side by side at preset intervals with respect to the position where the liquid is present.

Meanwhile, when the body travels along a first direction and reaches an outer edge of a region where the liquid is present, the body may travel through the position where the liquid is present along a second direction perpendicular to the first direction.

Meanwhile, the body may start backward traveling from a plurality of points centered on the position where the liquid is present.

Meanwhile, the wet cleaning unit includes a pair of mops configured to wipe the floor surface by rotation, wherein a rotation direction of the mops when wiping the floor surface while moving backward may be opposite to a rotation direction of the mops when wiping the floor surface while moving forward.

Meanwhile, a control method of a robot cleaner, the method may include a zone setting step of detecting liquid on a floor surface and setting a zone in a region where the liquid is present; and a cleaning step of cleaning the region where the liquid is present while traveling therethrough, and the cleaning step comprises a backward cleaning step of traveling through the region where the liquid is present in a direction opposite to a traveling direction in the zone setting step.

In this case, the cleaning step includes a backward cleaning step of traveling backward through the region where the liquid is present.

In addition, the cleaning step may include a forward traveling step of traveling forward after the backward cleaning step.

Meanwhile, in the cleaning step, when the robot cleaner reaches an outer edge of the region where the liquid is present, the robot cleaner may travel through the region where the liquid is present by moving backward along a direction intersecting a direction in which the robot cleaner traveled in the backward cleaning step.

Meanwhile, in the zone setting step, an origin may be set on the region where the liquid is present, and a circular divided area may be set around the origin.

Accordingly, in the cleaning step, the liquid may be collected toward the origin.

As described above, according to the robot cleaner and the method for controlling the same of the present disclosure, when liquid is spilled on a floor surface, a predetermined origin is set, and the liquid is wiped while being gathered toward the origin, thereby effectively preventing the liquid from spreading to surroundings.

In addition, when cleaning the liquid, the robot cleaner performs cleaning while moving backward so that a mop disposed behind wheels wipes the liquid before the wheels, thereby effectively preventing the wheels from being contaminated by the liquid.

### BRIEF DESCRIPTION OF DRAWINGS

FIG. 1 is a view for explaining a robot cleaner according to an embodiment of the present disclosure;

FIG. 2 is a side view of FIG. 1;

FIG. 3 is a bottom view of FIG. 1;

FIG. 4 is a rear view of FIG. 1;

FIG. 5 is a view for explaining control of a robot cleaner according to an embodiment of the present disclosure;

FIG. 6 is a flowchart illustrating a method for controlling a robot cleaner according to an embodiment of the present disclosure; and

FIGS. 7 to 22 are views illustrating a robot cleaner traveling according to a method for controlling a robot cleaner according to an embodiment of the present disclosure.

### DETAILED DESCRIPTION OF SPECIFIC EMBODIMENTS

Hereinafter, desirable embodiments of the present disclosure will be described in detail with reference to the accompanying drawings.

The present disclosure may be modified in various ways and may have various embodiments. Specific embodiments are exemplified in the drawings and described in detail in the detailed description. This is not intended to limit the present disclosure to specific embodiments, and it should be interpreted as including all modifications, equivalents, and substitutions included in the spirit and technical scope of the present disclosure.

Although terms such as first, second, etc., may be used to describe various components in describing the present disclosure, the components are not limited by the terms. The terms are only for the purpose of distinguishing one component from another component. For example, a first component may be named a second component and, similarly, a second component may be named a first component without departing from the scope of the present disclosure.

The term "and/or" may include a combination of a plurality of related described items or any one of a plurality of related described items.

When a component is referred to as being "connected" or "coupled" to another component, it may be understood that the component may be directly connected or coupled to the other component, but an intervening component may also be present. On the other hand, when a component is referred to as being "directly connected" or "directly coupled" to another component, it may be understood that no intervening component is present.

The terminology used in the present application is for the purpose of describing specific embodiments only and is not intended to limit the present disclosure. As used herein, the singular forms are intended to include the plural forms as well, unless the context clearly indicates otherwise.

In the present application, terms such as "comprises," "includes," or "has" are intended to designate the presence of features, numbers, steps, operations, components, parts, or combinations thereof described in the specification, and should be understood not to preclude the presence or addition of one or more other features, numbers, steps, operations, components, parts, or combinations thereof.

Unless otherwise defined, all terms including technical or scientific terms used herein have the same meaning as commonly understood by one of ordinary skill in the art to which the present disclosure belongs. Terms such as those defined in commonly used dictionaries should be interpreted as having a meaning consistent with their meaning in the context of the relevant art and, unless explicitly defined in the present application, are not to be interpreted in an idealized or overly formal sense.

In addition, the following embodiments are provided to more completely explain the present disclosure to those with average knowledge in the art, and the shapes and sizes of elements in the drawings may be exaggerated for clarity of description.

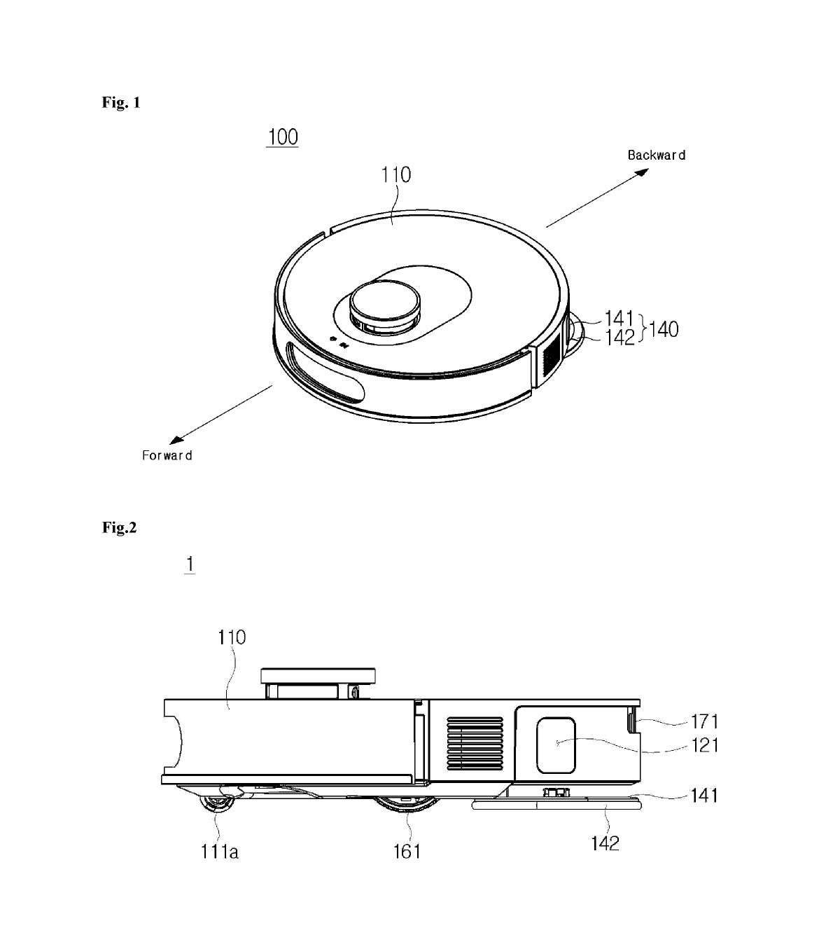

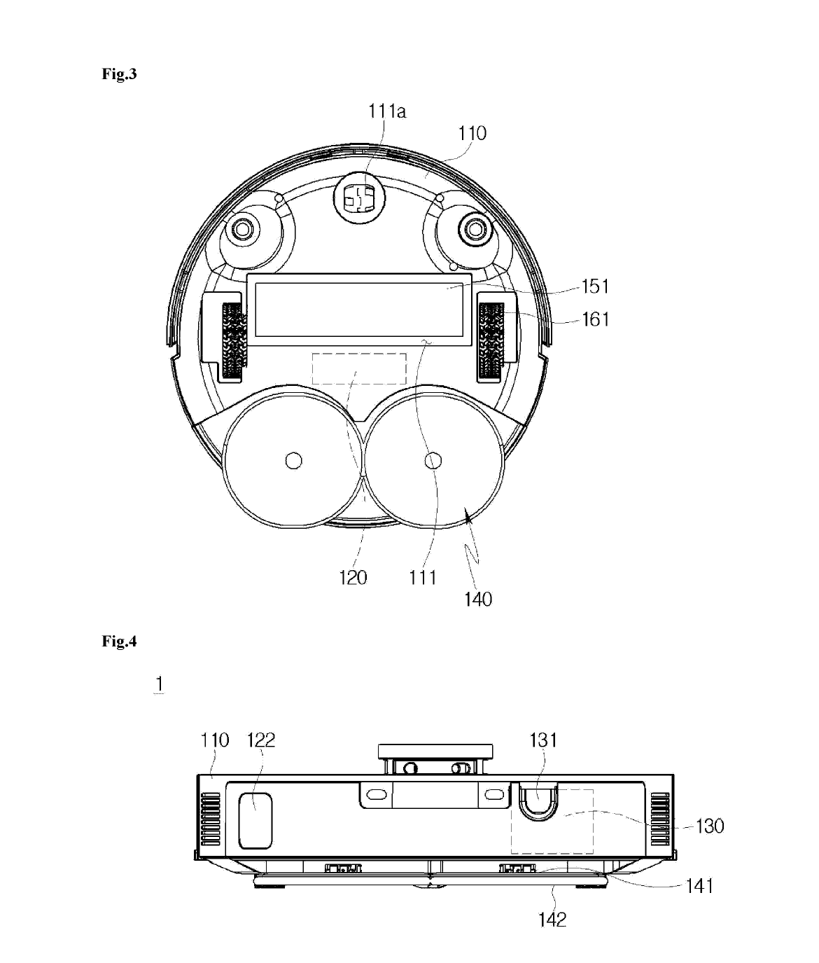

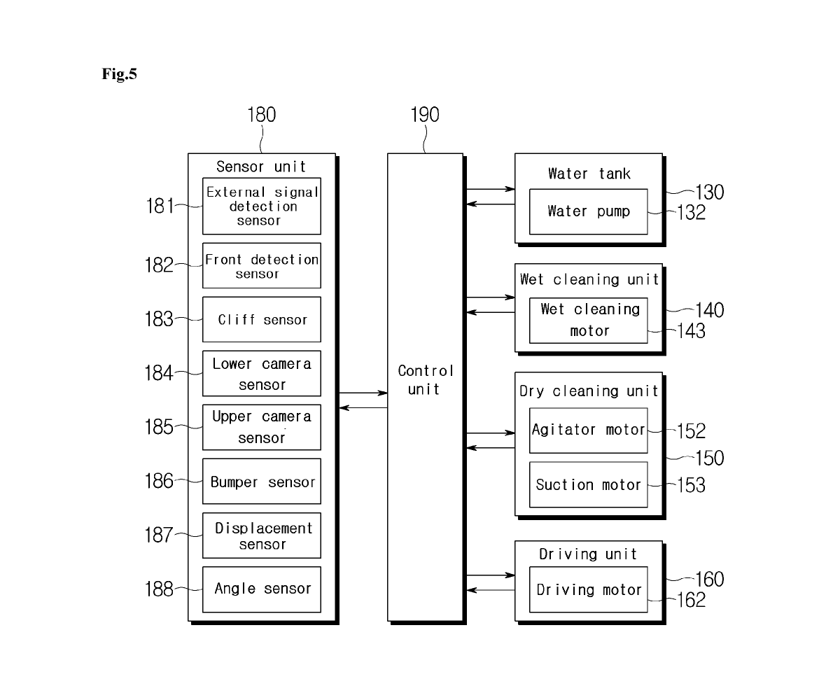

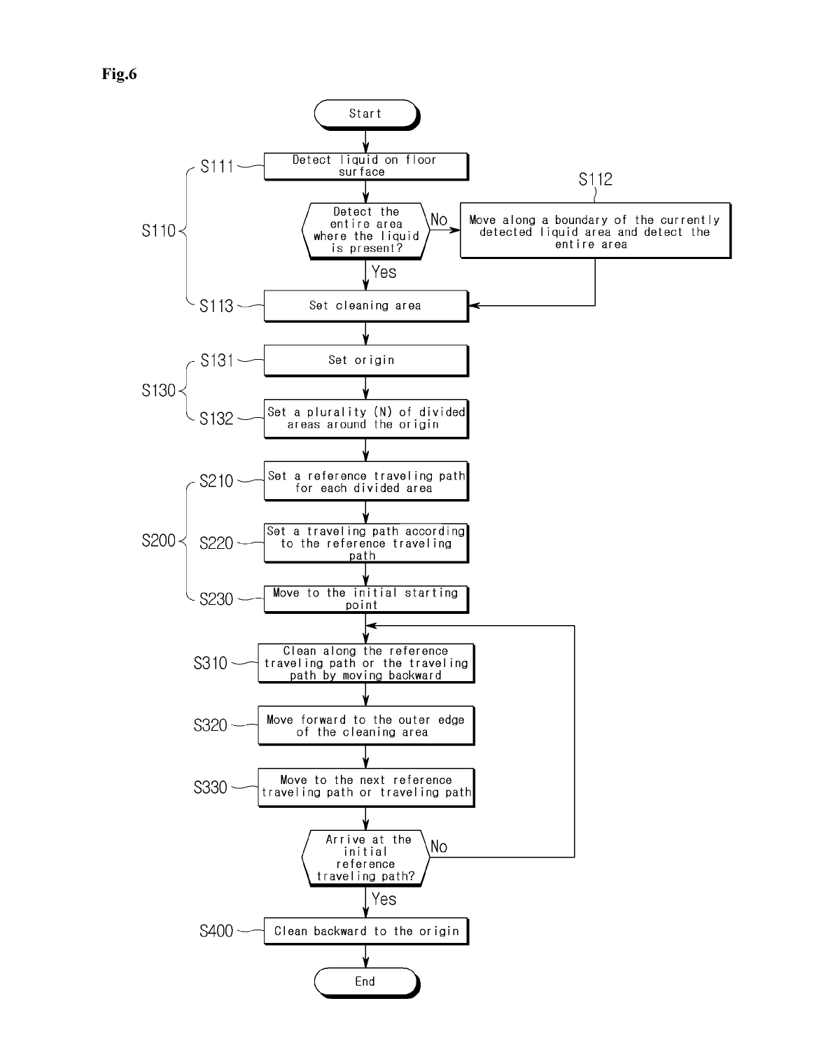

Meanwhile, FIGS. 1 to 4 disclose views for explaining a robot cleaner according to an embodiment of the present disclosure.

A structure of the robot cleaner (1) will be described as follows with reference to FIGS. 1 to 4.

The robot cleaner 1 may automatically clean an area to be cleaned by autonomously traveling within the area and suctioning foreign substances such as dust from a floor.

The robot cleaner 1 according to an embodiment of the present disclosure is configured to be placed on a floor and clean the floor while moving along a floor surface. Accordingly, hereinafter, the vertical direction will be defined and described based on a state in which the robot cleaner 1 is placed on the floor.

Further, based on a pair of wheels 161, a side where an auxiliary wheel 111a to be described later is disposed is defined as a front side, and a side where a wet cleaning unit 140 to be described later is disposed is defined as a rear side. In addition, a left side and a right side are defined based on a view from the wet cleaning unit 140 toward the auxiliary wheel 111a.

The "lowest part" of each component described in an embodiment of the present disclosure may be a part positioned lowest in each component or a part closest to the floor when the robot cleaner 1 according to an embodiment of the present disclosure is placed on the floor for use.

The robot cleaner 1 according to an embodiment of the present disclosure includes a body 110, a dust bin 120, a water tank 130, a wet cleaning unit 140, a dry cleaning unit 150, and a driving unit 160.

The body 110 may form an overall appearance of the robot cleaner 1. Various components constituting the robot cleaner 1 may be coupled to the body 110, and some components constituting the robot cleaner 1 may be accommodated inside the body 110.

Specifically, the body 110 may be provided with components of the robot cleaner 1 in an internal space thereof. For example, the body 110 may accommodate a battery and at least one motor in the internal space.

In an embodiment of the present disclosure, the body 110 may be formed in a shape in which a width (or diameter) in a horizontal direction (direction parallel to X and Y) is larger than a height in a vertical direction (direction parallel to Z). Such a body 110 helps the robot cleaner 1 achieve a stable structure and may provide a structure advantageous for avoiding obstacles during movement (traveling) of the robot cleaner 1.

When viewed from above or below, the body 110 may be formed in various shapes such as a circular, elliptical, or rectangular shape.

The body 110 may be divided into a lower body and an upper body, and the lower body and the upper body may be coupled to each other to form a space therein.

The lower body may be coupled to the upper body to form a space for accommodating a battery, at least one sensor, and at least one motor therein.

A suction port 111 through which air is introduced and holes for accommodating a pair of wheels 161 may be formed in the lower body.

The suction port 111 may be a passage through which dust on the floor surface is introduced. Further, the suction port 111 may communicate with a suction flow path (not shown) formed inside the body 110, and the suction flow path may communicate with an internal space of the dust bin 120.

Meanwhile, an exhaust flow path may be further provided in the lower body. One side of the exhaust flow path may communicate with the internal space of the dust bin 120, and the other side thereof may communicate with an exhaust port. At this time, a filter may be disposed at the exhaust port.

With such a configuration, air introduced through the suction port 111 may flow into the dust bin 120 through the suction flow path, and may be discharged to the exhaust port through the exhaust flow path.

An agitator 151 of a dry cleaning unit 150, which will be described later, may be rotatably accommodated in the suction port 111. With such a configuration, dust around the suction port 111 may be guided into the suction port 111 by rotation of the agitator 151, and the efficiency of suctioning dust may be increased.

The upper body may form an upper appearance of the robot cleaner 1. Although not shown, the upper body may be provided with a display.

Although not shown, the robot cleaner 1 of the present disclosure may include a bumper. The bumper is coupled along a periphery of the body 110 and is configured to move relative to the body 110.

The bumper may be coupled along a part of the periphery of the body 110, or may be coupled along the entire periphery of the body 110. At least one elastic member (not shown) may be provided between the bumper and the body 110. With such a configuration, when the bumper moves relatively toward a center of the body 110 by contacting an obstacle or the like, the bumper may return to an original position by a restoring force of the elastic member (not shown), and may absorb or disperse an impact applied to the bumper, thereby preventing or reducing transmission of the impact to the body 110.

An auxiliary wheel 111a is provided on a lower surface of the body 110 and may roll on a floor surface (a surface to be cleaned). The auxiliary wheel 111a may support the body 110 on the floor surface together with a pair of wheels 161. With such a configuration, the auxiliary wheel 111a may guide movement of the robot cleaner 1 while minimizing friction between the robot cleaner 1 and the floor surface.

The dust bin 120 may be provided to suction external dust and air and to store the dust.

The dust bin 120 may store dust introduced through the suction flow path. The dust bin 120 may include a dust inlet communicating with the suction flow path, an internal space for storing the dust, and an air outlet through which air may be discharged.

The dust bin 120 may be provided inside the body 110. In this case, the dust bin 120 may be fixedly coupled to the body 110 or may be detachably provided according to embodiments.

Meanwhile, in the present disclosure, a dust discharge flow path may be formed in the dust bin 120. The dust discharge flow path may communicate the internal space of the dust bin 120 with an external space of the robot cleaner 1. With such a configuration, when collecting dust through a robot cleaner station 100, the dust inside the dust bin 120 may be removed.

Meanwhile, in the dust bin 120 according to an embodiment of the present disclosure, a dust discharge port 121 communicating with the dust discharge flow path may be formed. As an example, the dust discharge port 121 may be formed at a rear side of an outer surface (or an outer circumferential surface) of the body 110. As another example, the dust discharge port 121 may be formed on an outer surface of the dust bin 120.

In addition, the robot cleaner 1 according to an embodiment of the present disclosure may be provided with a dust bin door 122 capable of selectively opening and closing the dust discharge port 121. Specifically, the dust bin door 122 may be coupled to the body 110 and disposed at a position capable of blocking the dust discharge port 121. As an example, the dust bin door 122 may be formed of a rubber or resin material and provided to be flippable, with one side thereof fixedly coupled to the body 110.

The water tank 130 is formed in a container shape including an internal space in which a liquid such as water is stored. The water tank 130 is disposed inside the body 110, and may be fixedly coupled to the body 110, or may be detachably coupled to the body 110.

The water tank 130 includes a supply unit 131 and a nozzle (not shown). The supply unit 131 may be provided such that a liquid such as water is supplied from the outside. For example, the supply unit 131 may have an inlet formed on a rear side of an outer surface (or an outer circumferential surface) of the body 110 and may be connected to a storage space inside the water tank 130 through a water supply hose.

In this case, the supply unit 131 may be disposed on a side opposite to a left/right direction of the robot cleaner 1 with respect to the dust discharge port 121. For example, if the dust discharge port 121 is disposed on a rear left side of the body 110, the supply unit 131 may be disposed on a rear right side of the body 110.

Meanwhile, the nozzle (not shown) is formed in a tube or pipe shape, and is connected to the water tank 130 such that the liquid inside the water tank 130 may flow therethrough. The nozzle (not shown) is arranged such that one side thereof is connected to the water tank 130 and the other side end is located above a pair of rotating plates 141, thereby allowing the liquid inside the water tank 130 to be supplied to a pair of mops 142.

That is, the nozzle (not shown) may be formed in a shape in which one pipe is branched into two, wherein one branched end may be positioned above a left rotating plate and the other branched end may be positioned above a right rotating plate.

Meanwhile, a water pump 132 is provided in the water tank 130 to cause water inside the water tank 130 to flow toward the nozzle (not shown). Therefore, when the water pump 132 of the water tank 130 is operated, the liquid stored in the water tank 130 may be discharged to the wet cleaning unit 140 through the nozzle (not shown).

The water pump 132 may be provided to adjust a supply amount of liquid (water) supplied to the mop 142 during a cleaning operation of the robot cleaner 1 according to a control signal from a controller 190. The controller 190 may control a driving time of a motor for driving the water pump 132 to adjust the supply amount.

The wet cleaning unit 140 includes a rotating plate 141 and a mop 142.

The rotating plate 141 may be provided in a pair including a left rotating plate 141a and a right rotating plate 141b, and the mop 142 may be provided in a pair including a left mop 142a and a right mop 142b.

The rotating plate 141 may be rotatably disposed on a bottom surface of the body 110, and the mop 142 may be coupled to a lower side thereof.

The rotating plate 141 is formed to have a predetermined area and is formed in a shape of a flat plate or a flat frame. Such a rotating plate 141 is generally laid horizontally and thus formed in a shape in which a horizontal width (or diameter) is sufficiently larger than a vertical height. The rotating plate 141 coupled to the body 110 may be parallel to a floor surface B or may be inclined with respect to the floor surface B. The rotating plate 141 may be formed in a circular plate shape, a bottom surface of the rotating plate 141 may be generally circular, and the rotating plate 141 may be formed in a rotationally symmetrical shape as a whole.

The pair of rotating plates 141 may be symmetrical to each other in a left-right direction.

The mop 142 may be coupled to a lower side of the rotating plate 141 so as to face the floor surface B.

The mop 142 is configured such that a bottom surface thereof facing the floor has a predetermined area, and the mop 142 is formed in a flat shape. The mop 142 is formed in a shape in which a width (or diameter) in a horizontal direction is sufficiently larger than a height in a vertical direction. When the mop 142 is coupled to the body 110, the bottom surface of the mop 142 may be parallel to the floor surface B or may be inclined with respect to the floor surface B.

The bottom surface of the mop 142 may be generally circular, and the mop 142 may be formed in a rotationally symmetrical shape as a whole. In addition, the mop 142 may be detachably attached to the bottom surface of the rotating plate 141 and may be coupled to the rotating plate 141 to rotate together with the rotating plate 141.

Meanwhile, although not shown, the wet cleaning unit 140 may be provided with a wet cleaning motor 143 for applying a rotational force to the rotating plate 141. For example, the wet cleaning motor 143 may include a motor and at least one gear. Accordingly, when the wet cleaning motor 143 is operated, the rotating plate 141 and the mop 142 rotate to wipe and clean the floor surface. As an example, a pair of wet cleaning motors 143 may be provided to respectively control each of the pair of rotating plates 141; in this case, rotational speeds of the pair of rotating plates 141 may be controlled differently. Alternatively, it is also possible to use a single wet cleaning motor 143 such that rotational directions of the pair of rotating plates 141 are opposite to each other through gears.

The dry cleaning unit 150 includes an agitator 151, an agitator motor 152, and a suction motor 153.

The agitator 151 is provided with a plurality of brushes rotatably to guide external dust and air to the dust bin 120. At this time, the dry cleaning unit 150 may be provided with at least one gear to transfer power of the agitator motor 152 to the agitator 151.

The agitator motor 152 may generate rotational power for the agitator 151. Meanwhile, a separate agitator motor 152 may be installed to generate the rotational power according to the present embodiment, or it is also possible to receive rotational power from a driving motor 162 or from a wet cleaning motor 143 of a wet cleaning unit 140 according to embodiments.

The suction motor 153 may generate suction force capable of suctioning external dust and air through the suction port 111. As an example, the suction motor 153 may be an electric motor. External dust and air may be introduced into the suction port 111 by the suction force generated by the suction motor 153, and may reach the dust bin 120 after passing through a suction flow path.

The driving unit 160 includes a wheel 161 and a driving motor 162.

The wheel 161 may be provided on a bottom surface of the body 110 and may be connected to the driving motor 162. In this case, the driving motor 162 may be coupled to the body 110.

The wheel 161 is provided on the body 110 and is configured to roll on a floor surface.

The wheel 161 may include a first driving wheel and a second driving wheel. In this case, the first driving wheel may be configured identically to the second driving wheel or may be configured to be symmetrical with the second driving wheel. For example, if the first driving wheel is positioned at a left side of the robot cleaner 1, the second driving wheel may be positioned at a right side of the robot cleaner 1, and the first driving wheel and the second driving wheel may be symmetrical to each other in a lateral direction.

A driving actuator (not shown) may include the driving motor 162 and a gear. In this case, the driving motor 162 may be accommodated inside the body 110 and may provide driving force to the wheel 161. The driving motor 162 may include a first driving motor and a second driving motor.

The driving motor 162 may be an electric motor. A plurality of gears are configured to rotate while being engaged with each other, connect the driving motor 162 to the wheel 161, and transfer rotational power of the driving motor 162 to the wheel 161. Accordingly, the wheel 161 may rotate when a shaft of the driving motor 162 rotates.

With this configuration, when the driving motor 162 is operated, the wheel 161 rotates, and the body 110 may travel on a floor surface at a predetermined traveling speed.

The battery 170 is coupled to the body 110 and is configured to supply power to other components of the robot cleaner 1. The battery 170 may supply power to at least one motor provided in the robot cleaner 1. For example, the battery 170 may supply power to motors provided in the wet cleaning unit 140, the dry cleaning unit 150, and the driving unit 160.

In addition, the battery 170 may supply power to the sensor unit 180 and the control unit 190.

The battery 170 may be charged by an external power source, and for this purpose, a charging terminal 171 for charging may be provided at one side of the body 110. For example, the charging terminal 171 may be disposed at a rear side of an outer surface of the body 110.

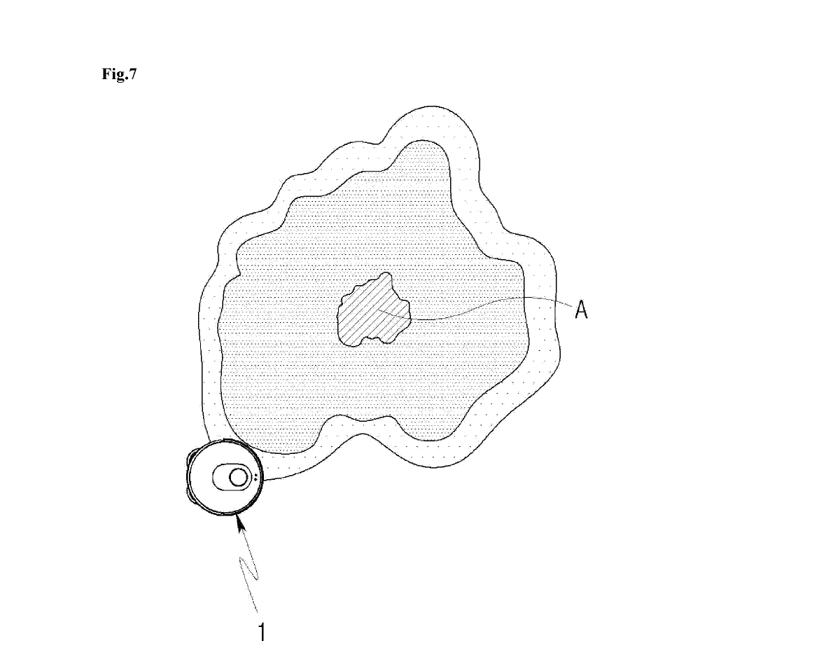

Meanwhile, FIG. 5 illustrates a configuration for controlling the robot cleaner 1 according to an embodiment of the present disclosure.

Referring to FIG. 5, the robot cleaner 1 according to an embodiment of the present invention further includes a sensor unit 180 and a control unit 190.

The sensor unit 180 may include at least one of an external signal detection sensor 181, a front detection sensor 182, a cliff sensor 183, a lower camera sensor 184, and an upper camera sensor 185.

The external signal detection sensor 181 may detect an external signal of the robot cleaner. The external signal detection sensor 181 may be, for example, an infrared (IR) sensor, an ultrasonic sensor, a radio frequency (RF) sensor, or the like. Through the external signal detection sensor 181, a distance to a robot cleaner station (not shown), a charging dock, or another robot cleaner may be sensed, or information may be transmitted and received.

Meanwhile, the front detection sensor 182 is positioned on at least one side of the robot cleaner 1 and is configured to detect an obstacle in front. The front detection sensor 182 may detect an object, particularly an obstacle, existing in a moving direction of the robot cleaner 1 and transfer detection information to the control unit 190. That is, the front detection sensor 182 may detect a protrusion, household appliances, furniture, a wall, a wall corner, and the like existing on a moving path of the robot cleaner 1 and transfer information thereof to the control unit 190.

The front detection sensor 182 may be, for example, an infrared sensor, an ultrasonic sensor, an RF sensor, a geomagnetic sensor, or the like. The robot cleaner 1 may use one type of sensor as the front detection sensor 182 or may use two or more types of sensors together as needed.

For example, the ultrasonic sensor may be generally used mainly to detect a long-distance obstacle. The ultrasonic sensor may include a transmitter and a receiver. The control unit 190 may determine the existence of an obstacle based on whether ultrasonic waves emitted through the transmitter are reflected by the obstacle and received by the receiver, and may calculate a distance to the obstacle using an ultrasonic emission time and an ultrasonic reception time.

As another example, the infrared sensor may also detect an obstacle existing in front or at a side and transfer obstacle information to the control unit 190. That is, the infrared sensor detects a protrusion, household appliances, furniture, a wall, a wall corner, and the like existing on the moving path of the robot cleaner 1 and transfers the information to the control unit 190. Accordingly, the robot cleaner may move within a specific area without the body colliding with an obstacle.

Meanwhile, the cliff sensor 183 may detect an obstacle on a floor supporting the body 110, mainly using various types of optical sensors.

That is, the cliff sensor 183 is positioned on a lower surface of the body 110 and is configured to detect an obstacle on the floor surface. Like the front detection sensor 182, the cliff sensor 183 may be an infrared sensor having a light emitting part and a light receiving part, an ultrasonic sensor, an RF sensor, a position sensitive detector (PSD) sensor, or the like.

For example, one of the cliff sensors 183 may be installed at a front of the robot cleaner 1, and two other cliff sensors 183 may be installed at a relatively rear side.

For example, the cliff sensor 183 may be a position sensitive detector (PSD) sensor, but may also be composed of a plurality of different types of sensors.

The PSD sensor is a type of infrared sensor, and measures a distance by measuring an angle of an infrared ray that is reflected from an obstacle after transmitting the infrared ray. That is, the PSD sensor calculates a distance to an obstacle using a triangulation method.

The control unit 190 may detect a cliff and analyze a depth thereof by measuring an infrared angle between a light emitting signal of infrared light emitted toward the ground by the cliff sensor 183 and a reflected signal received after being reflected by the obstacle.

Meanwhile, the control unit 190 may determine whether to pass according to a ground condition of the cliff detected using the cliff sensor 183, and may decide whether to pass the cliff according to a result of the determination. For example, the control unit 190 may determine the existence of a cliff and the depth of the cliff through the cliff sensor 183, and then allow the robot cleaner 1 to pass the cliff only when a reflected signal is detected through the cliff sensor 183.

As another example, the control unit 190 may also determine a lifting phenomenon of the robot cleaner 1 using the cliff sensor 183.

Meanwhile, the lower camera sensor 184 is provided on the lower surface of the robot cleaner 1 to acquire image information of a downward direction, that is, a floor surface (or a surface to be cleaned) during movement. The lower camera sensor 184 may also be referred to as an optical flow sensor. The lower camera sensor 184 generates image data of a predetermined format by converting a downward image input from an image sensor provided in the lower camera sensor 184. The generated image data may be stored in a memory.

In addition, one or more light sources may be installed adjacent to the image sensor. The one or more light sources irradiate light onto a predetermined area of the floor surface captured by the image sensor. That is, when the robot cleaner 1 moves in a specific area along the floor surface, a constant distance is maintained between the image sensor and the floor surface if the floor surface is flat. On the other hand, when the robot cleaner moves on an uneven floor surface, the robot cleaner is moved away by a certain distance or more due to irregularities or obstacles on the floor surface. In this case, the one or more light sources may be controlled by the control unit 190 to adjust an amount of light to be irradiated. The light source may be a light emitting device capable of adjusting an amount of light, for example, a light emitting diode (LED) or the like.

Using the lower camera sensor 184, the control unit 190 may detect a position of the robot cleaner 1 regardless of slipping of the robot cleaner 1. The control unit 190 may calculate a moving distance and a moving direction by comparing and analyzing image data captured by the lower camera sensor 184 over time, and may calculate the position of the robot cleaner 1 based on the calculated distance and direction.

Meanwhile, the upper camera sensor 185 may be installed to face upward or forward of the robot cleaner 1 to capture surroundings of the robot cleaner 1. When the robot cleaner 1 includes a plurality of upper camera sensors 185, the camera sensors may be formed on an upper surface or a side surface of the robot cleaner at a predetermined distance or a predetermined angle.

Meanwhile, the sensor unit 180 may be configured to detect movement (relative movement) of a bumper relative to the body 110. Such a bumper sensor 186 may be configured using a microswitch, a photo interrupter, a tact switch, or the like.

Meanwhile, the sensor unit 180 may further include a displacement sensor 187. The displacement sensor 187 is disposed on a lower surface (rear surface) of the body 110 and may measure a distance traveled along the floor surface.

Meanwhile, the sensor unit 180 may further include an angle sensor 188. The angle sensor 188 is disposed inside the body 110 and may measure a moving angle of the body 110. For example, the angle sensor 188 may use a gyro sensor that measures a rotation speed of the body 110. The gyro sensor may detect a direction of the robot cleaner 1 using the rotation speed.

With such a configuration, the angle sensor may detect an angle between a direction in which the robot cleaner 1 travels and a predetermined virtual line.

Meanwhile, the control unit 190 may be configured to control an operation of the driving motor 162 according to preset information or real-time information. For the control by the control unit 190, the robot cleaner 1 may be provided with a storage medium in which an application program is stored. The control unit 190 may be configured to control the robot cleaner 1 by driving the application program according to information input to the robot cleaner 1, information output from the robot cleaner 1, and the like.

The control unit 190 may control a traveling direction of the robot cleaner 1. That is, the control unit 190 may control a rotation speed of each of a pair of driving motors 162.

In this case, the control unit 190 may control the robot cleaner 1 to travel in a straight line or travel in a straight reciprocating manner, and may also control the robot cleaner 1 to travel overlappingly with respect to a predetermined area. In addition, the control unit 190 may control the robot cleaner 1 to travel according to a preset traveling pattern.

The control unit 190 may control the robot cleaner 1 to perform an avoidance maneuver when a bumper of the robot cleaner 1 contacts an obstacle, and may be configured to control the operation of the driving motor 162 according to information from the sensor unit 180. For example, when the bumper contacts an obstacle while the robot cleaner 1 is traveling, a position where the bumper has contacted may be identified by the sensor unit 180, and the control unit 190 may control the operation of the driving motor 162 to move away from the contact position.

The control unit 190 may control the operation of the driving motor 162 so that the traveling direction of the robot cleaner 1 is changed or the robot cleaner 1 moves away from the obstacle when a distance between the robot cleaner 1 and the obstacle is equal to or less than a predetermined value according to the information from the sensor unit 180.

In addition, the control unit 190 may control the operation of the driving motor 162 so that the robot cleaner 1 stops or the traveling direction is changed according to the distance detected by the sensor unit 180.

The control unit 190 may control the water pump 132. The water pump 132 may be configured to adjust a water supply amount of a liquid (water) supplied to the mop 142 during a cleaning operation of the robot cleaner 1 according to a control signal from the control unit 190. The control unit 190 may control a driving time of the water pump 132 to adjust the water supply amount.

The control unit 190 may control the wet cleaning unit 140. Specifically, the control unit 190 may control an output of the wet cleaning motor 143. That is, the control unit 190 may control a rotation speed and a rotation direction of the wet cleaning motor 143. Accordingly, the control unit 190 may control a rotation speed and a rotation direction of the mop 142.

The control unit 190 may control the dry cleaning unit 150. Specifically, the control unit 190 may control an output of the suction motor 153. That is, the control unit 190 may control a rotation speed of the suction motor 153. In addition, the control unit 190 may control the agitator motor 152 to control a rotation speed of the agitator 151.

In addition, the control unit 190 may control the output of the suction motor 153 according to an amount of dust on the floor surface. That is, the control unit 190 may detect the amount of dust existing on the floor surface through the sensor unit 180, and when it is determined that the amount of dust existing on the floor surface is greater than a predetermined reference value, the control unit 190 may increase the output of the suction motor 153.

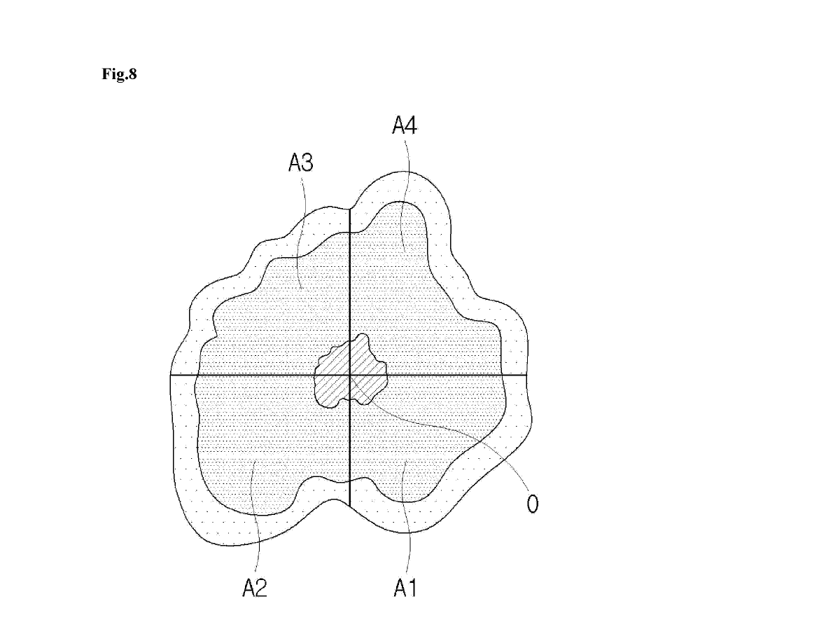

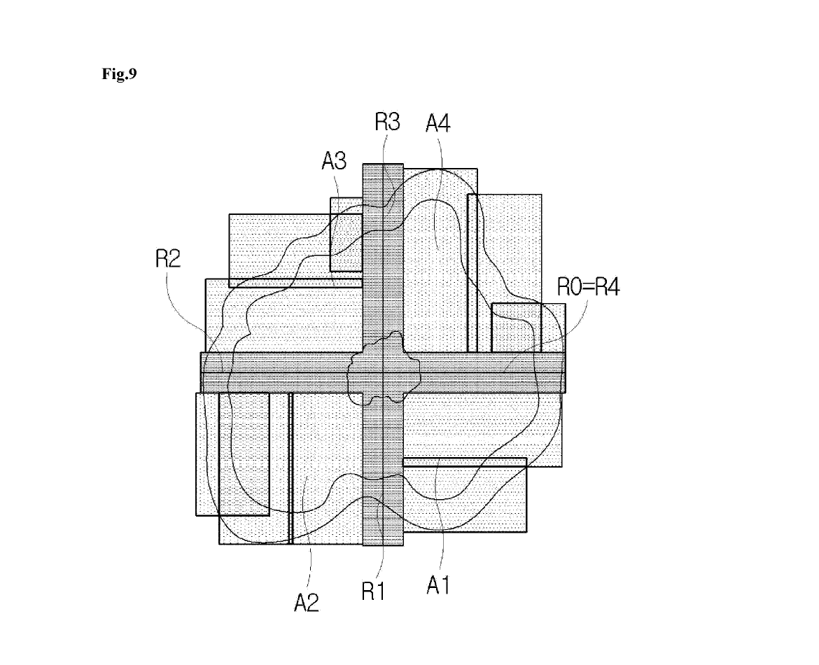

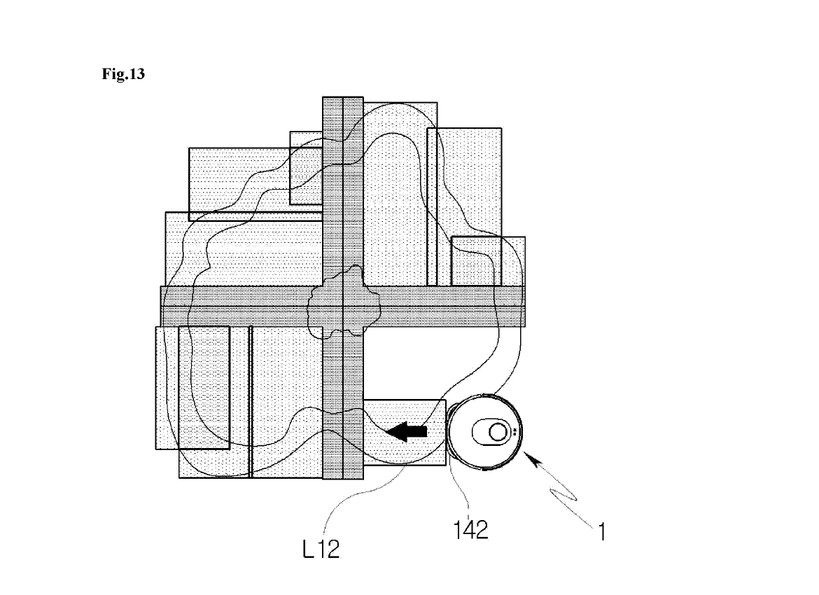

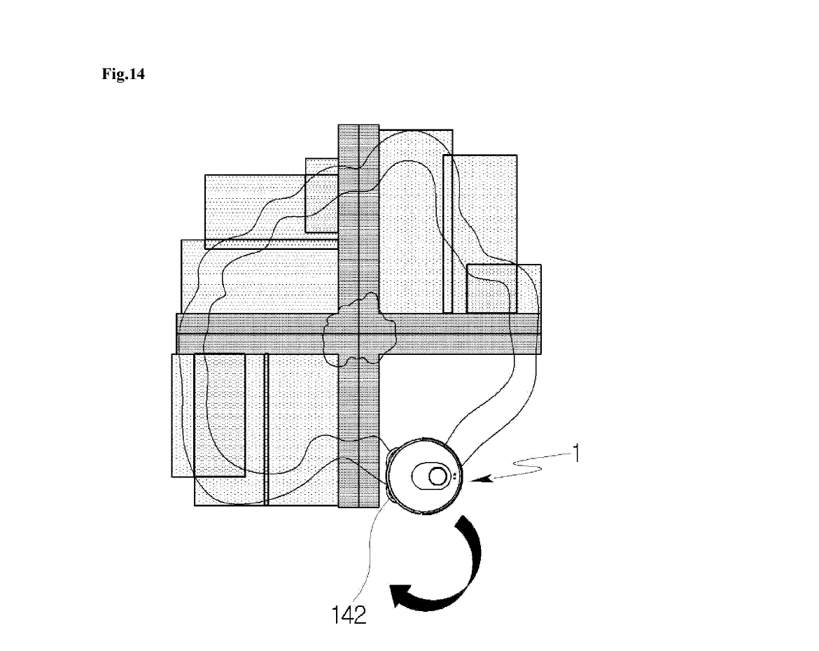

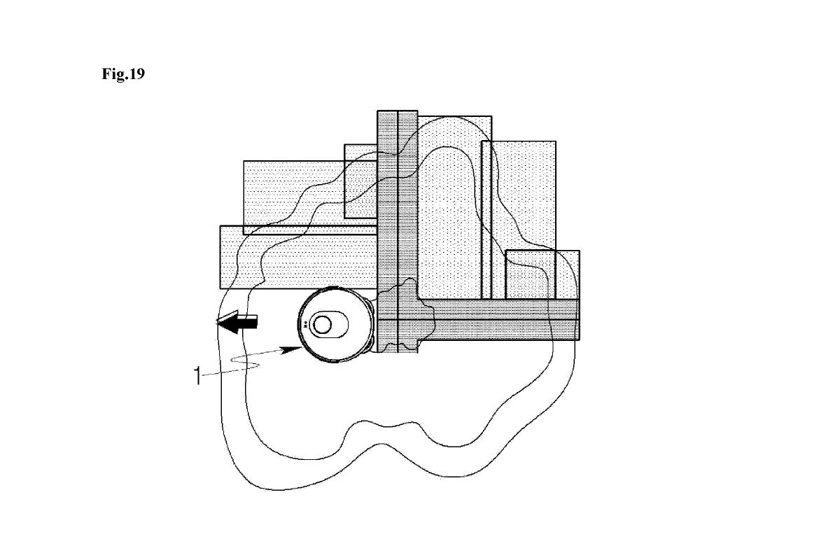

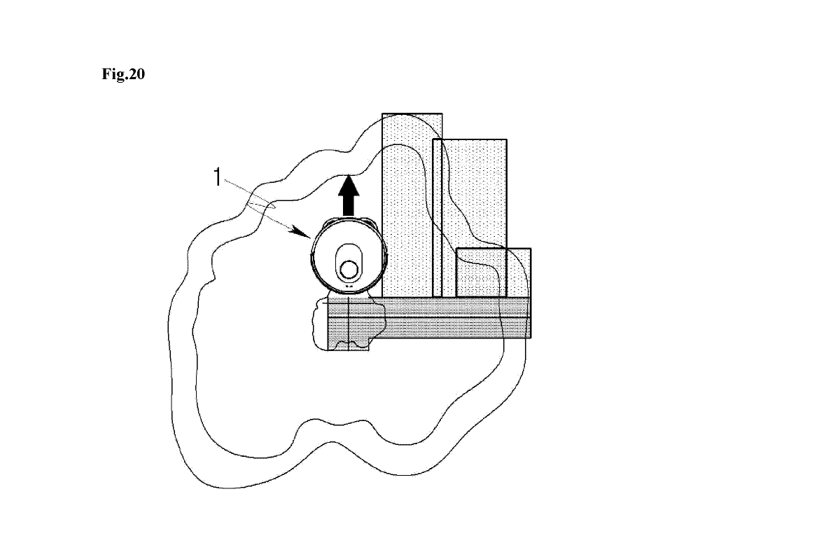

FIG. 6 is a flowchart illustrating a control method of a robot cleaner according to an embodiment of the present disclosure, and FIGS. 7 to 22 are views illustrating the control method of the robot cleaner according to an embodiment of the present disclosure.

The control method of the robot cleaner according to an embodiment of the present disclosure will be described with reference to FIGS. 6 to 22 as follows.

As a premise of the present disclosure, the robot cleaner 1 may include information on a surface to be cleaned. That is, a map of a cleaning area may be stored in a memory of the robot cleaner 1. For example, the information on the surface to be cleaned may be map information mapped by the robot cleaner 1 itself.

Alternatively, when a map of the cleaning area is not stored in the robot cleaner 1, or when a drawing for a new map is required, a map may be generated (mapped) by traveling in the cleaning area through wall following or the like. In addition, the robot cleaner 1 may generate a map through obstacle information acquired while performing cleaning of the cleaning area in a state where there is no map.

In addition, the sensor unit 180 may detect an obstacle including a wall or the like during traveling of the robot cleaner 1 or before starting the traveling, and the robot cleaner 1 may generate a map of a floor surface B through the obstacle information.

Meanwhile, the map generation method of the robot cleaner 1 may apply various known methods, and thus a detailed description thereof will be omitted.

A control method of a robot cleaner according to an embodiment of the present disclosure includes a zone setting step S100, a path setting step S200, a cleaning step S300, and a cleaning termination step S400.

The zone setting step S100 includes a cleaning area setting step S110 and a divided area setting step S130.

In the cleaning area setting step S110, a cleaning area A may be set on a floor surface B.

For example, in the cleaning area setting step S110, the sensor unit 180 may detect foreign substances on the floor surface B, and the control unit 190 may set the cleaning area A by reflecting positions of the foreign substances.

In the cleaning area setting step S110 according to the present disclosure, the sensor unit 180 may detect liquid on the floor surface B, and the control unit 190 may set the cleaning area A by reflecting a position where the liquid is spread (refer to FIG. 7).

For example, in the cleaning area setting step S110, the lower camera sensor 184 may detect the liquid on the floor surface B (S111).

Meanwhile, in the cleaning area setting step S110, the control unit 190 may detect the liquid on the floor surface B while traveling forward. Specifically, the control unit 190 may control the driving unit 160 to control the robot cleaner 1 to move forward. Accordingly, a pair of wheels 161 may be rotated to cause the robot cleaner 1 to move forward. Here, the term "forward" may mean traveling in a direction in which the auxiliary wheel 111a is disposed relative to the wheel 161. Alternatively, the term "forward" may mean that a part of the robot cleaner 1 where a bumper is disposed moves forward. Alternatively, the term "forward" may mean that a side opposite to a part of the robot cleaner 1 where the water tank 130 is disposed moves forward. Alternatively, the term "forward" may mean that the robot cleaner 1 travels toward a target point in a state where the wet cleaning unit 140 is disposed closer than the suction unit 111.

In this case, when the lower camera sensor 184 detects the entire range of the liquid spilled on the floor surface B at a position where the robot cleaner 1 is disposed, the control unit 190 may set the cleaning area A by expanding the range where the liquid exists by a preset ratio (S113).

Alternatively, when the lower camera sensor 184 does not detect the entire range of the liquid spilled on the floor surface B at the position where the robot cleaner 1 is disposed, the control unit 190 may control the robot cleaner 1 to travel around the range where the liquid exists (S112). After detecting the entire range where the liquid exists, the control unit 190 may set the cleaning area A by expanding the range where the liquid exists by a preset ratio (S113).

Accordingly, in the cleaning area setting step S110, a boundary of the cleaning area A may be set through the liquid detection of the control unit 190.

In the divided area setting step S130, the cleaning area A set in the cleaning area setting step S110 may be divided into a plurality of divided areas A1, A2, ... An (refer to FIG. 8).

In the divided area setting step S130, the control unit 190 may set an origin O within the cleaning area A (S131). In this case, the origin O may be any one point inside the range where the liquid exists on the floor surface. For example, the origin O may be a midpoint of a widest part among regions where the liquid is distributed on the floor surface. As another example, the origin O may be a center of gravity of the region where the liquid is distributed on the floor surface.

Subsequently, the control unit 190 may set N divided areas A1, A2, ... AN by dividing the cleaning area A at constant angular intervals along a circumferential direction around the origin O (S132). For example, the control unit 190 may set four divided areas A1, A2, A3, and A4 by dividing the cleaning area A at intervals of 90 degrees along the circumferential direction around the origin O.

After the zone setting step S100, in the path setting step S200, a traveling path for the robot cleaner 1 to travel may be set. In the path setting step S200, the control unit 190 may set a traveling path for each of the divided areas A1, A2, ... AN.

First, the control unit 190 may set a reference traveling path passing through the origin O (S210). In this case, the reference traveling path may mean a path along which the robot cleaner 1 travels to collect liquid toward the origin O after cleaning each divided area A1, A2, ... AN. That is, the control unit 190 may set reference traveling paths R1, R2, ... RN corresponding to the respective divided areas A1, A2, ... AN.

In addition, the control unit 190 may further set a reference traveling path R0 that serves as a reference for the entire cleaning area A (hereinafter, referred to as an "initial reference traveling path"). In this case, the initial reference traveling path R0 may coincide with a reference traveling path RN of an N-th divided area AN. That is, the initial reference traveling path R0 may coincide with a path RN along which the robot cleaner 1 travels to collect the liquid toward the origin O after cleaning a last divided area AN (refer to FIG. 9).

Through this, the control unit 190 may control the robot cleaner 1 to complete traveling over an entire 360-degree range around the origin O to collect the liquid toward the origin O.

Then, the control unit 190 may set a traveling path for each divided area A1, A2, ... AN (S220). The traveling path for each divided area A1, A2, ... AN may be set using the reference traveling paths R0, R1, R2, ... RN.

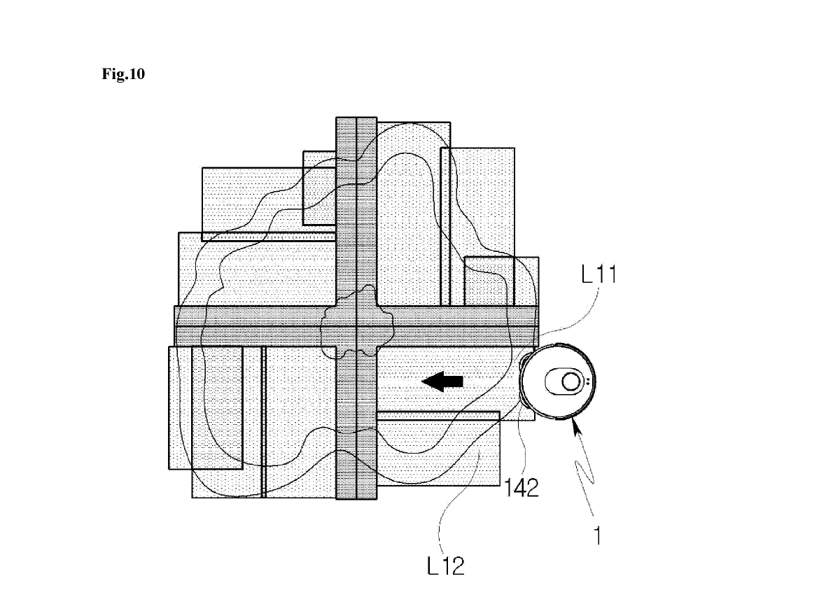

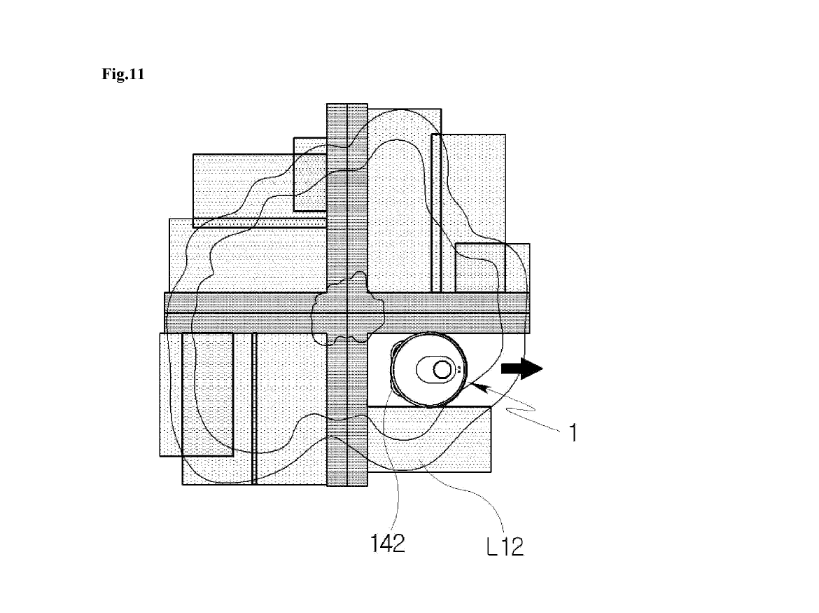

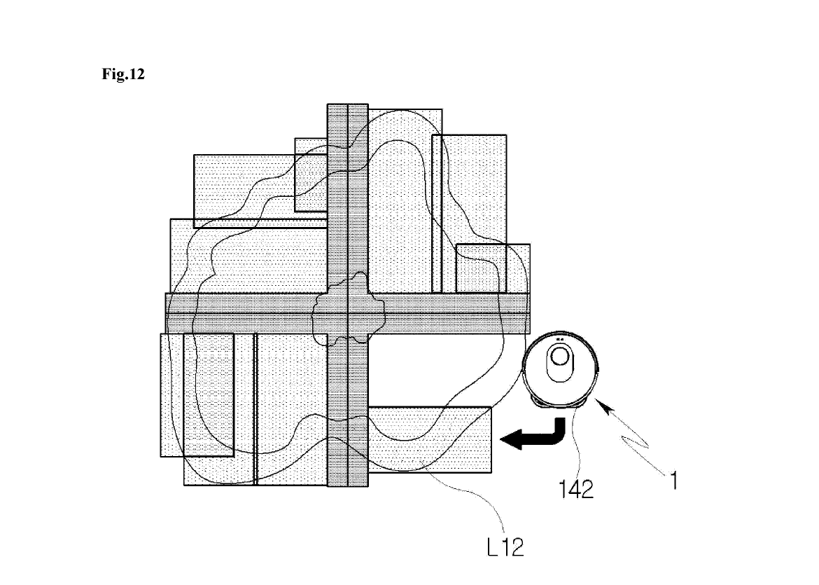

Specifically, the traveling path for each divided area A1, A2, ... AN may be set to be parallel to a reference traveling path of a previous divided area, start at an outer edge of a corresponding divided area, and end at a point where the traveling path meets a reference traveling path of the corresponding divided area. For example, a traveling path L1 for a first divided area A1 may be set to be parallel to the initial reference traveling path R0, start at an outer edge of the first divided area A1, and end at a point where the traveling path L1 meets the reference traveling path R1 of the first divided area (refer to FIG. 10).

Meanwhile, a plurality of traveling paths for each of the divided areas A1, A2, ... AN may be set to be parallel to each other at predetermined distance intervals. That is, when a movement distance of a reference traveling path in a corresponding divided area is greater than a maximum width of the mop 142 of the robot cleaner 1, the control unit 190 may set a plurality of parallel traveling paths because the corresponding divided area needs to be wiped while reciprocating a plurality of times. However, starting points of the plurality of traveling paths may differ from each other according to a distribution of the first divided area A1.

In this case, an interval between the plurality of traveling paths may be smaller than the maximum width of the mop 142 of the robot cleaner 1. Accordingly, when the robot cleaner 1 travels along the traveling path, the mop 142 of the robot cleaner 1 may overlappingly wipe the floor surface B. Through this, a cleaning effect of the robot cleaner 1 may be improved.

For example, when a distance D of the first reference traveling path R1 is greater than a maximum width w of the mop 142 of the robot cleaner 1 (D > w), the control unit 190 may set a plurality of (n) parallel traveling paths L11, L12, ... L1n. In this case, the control unit 190 may set a product of the number of traveling paths (n) and the maximum width (w) of the mop 142 to be greater than the distance D of the first reference traveling path R1 (n × w > D). Additionally, the control unit 190 may set an interval between the plurality of (n) traveling paths to be smaller than the maximum width w of the mop 142, such that an arrival point of an n-th traveling path is disposed on the first reference traveling path R1. Through this, overlapping cleaning of the floor surface is possible, and there is an effect of collecting liquid onto the reference traveling path.

Meanwhile, in the path setting step S200, after setting of the traveling paths is completed, the control unit 190 may control the robot cleaner 1 to move to an initial starting point (S230). In this case, the control unit 190 may control the pair of driving motors 162 to rotate the wheels 161, targeting a starting point of a first traveling path L11 of the first divided area A1.

At this time, in the step of moving the robot cleaner 1 to the initial starting point (S230), the control unit 190 may cause the robot cleaner 1 to travel forward. Specifically, the control unit 190 may control the driving unit 160 to control the robot cleaner 1 to move forward. Accordingly, the pair of wheels 161 may be rotated to cause the robot cleaner 1 to move forward. Here, the term "forward" may mean traveling in a direction in which the auxiliary wheel 111a is disposed relative to the wheel 161. Alternatively, the term "forward" may mean that a part of the robot cleaner 1 where a bumper is disposed moves forward. Alternatively, the term "forward" may mean that a side opposite to a part of the robot cleaner 1 where the water tank 130 is disposed moves forward.

Meanwhile, in the step of moving the robot cleaner 1 to the initial starting point (S230), the robot cleaner 1 may travel while bypassing the cleaning area A. Through this, the liquid on the floor surface may be prevented from spreading.

Meanwhile, in the step of moving the robot cleaner 1 to the initial starting point (S230), the control unit 190 may operate the dry cleaning unit 150. That is, the control unit 190 may operate the agitator motor 152 and the suction motor 153 simultaneously with operating the driving motor 162.

In addition, in the step of moving the robot cleaner 1 to the initial starting point (S230), the control unit 190 may operate the wet cleaning unit 140. That is, the control unit 190 may operate the wet cleaning motor 143 simultaneously with operating the driving motor 162.

In this case, the pair of rotary plates 141 may be rotated in directions opposite to each other. For example, when viewed from a lower side of the robot cleaner 1, the left rotary plate 141a may rotate in a counterclockwise direction, and the right rotary plate 141b may rotate in a clockwise direction. Through this, the pair of rotary plates 141 may rotate to wipe while collecting foreign substances, such as liquid, toward an inner side of the robot cleaner 1.

In the cleaning step S300, the robot cleaner 1 may travel along the traveling path set in the path setting step S200. In the cleaning step S300, the control unit 190 may control the driving motor 162 to travel along the traveling path and the reference traveling path set in the path setting step S200.

Particularly, in the present disclosure, in the cleaning step S300, the robot cleaner 1 may clean liquid present on the floor surface while moving backward through the cleaning area A.

In the robot cleaner 1 of the present disclosure, the wet cleaning unit 140 is disposed rearward of the dry cleaning unit 150. Accordingly, when the robot cleaner 1 performs cleaning while moving forward, the dry cleaning unit 150 may suck in foreign substances such as dust present on the floor surface, and then the wet cleaning unit 140 may wipe and clean the floor surface.

Meanwhile, when liquid is present on the floor surface, if the robot cleaner 1 performs cleaning while moving forward, the liquid may be sucked into the suction unit 111, thereby contaminating an inside of the dust bin 120 with the liquid. Therefore, in the present disclosure, when the robot cleaner 1 detects that liquid is present on the floor surface, the robot cleaner 1 may clean the floor surface while collecting the liquid by moving backward in order to prevent the suction unit 111 from sucking in the liquid.

The cleaning step S300 includes a backward cleaning step S310, a forward traveling step S320, and a path switching step S330.

In the backward cleaning step S310, the robot cleaner 1 may travel backward through a region where liquid is present. In the backward cleaning step S310, the robot cleaner 1 may travel backward along a current traveling path where the robot cleaner 1 is located and a reference traveling path.

For example, immediately after the step of moving to the initial starting point (S230), the robot cleaner 1 is located at a starting point of a first traveling path L11, and may travel backward along the first traveling path L11 from this point (refer to FIG. 10).

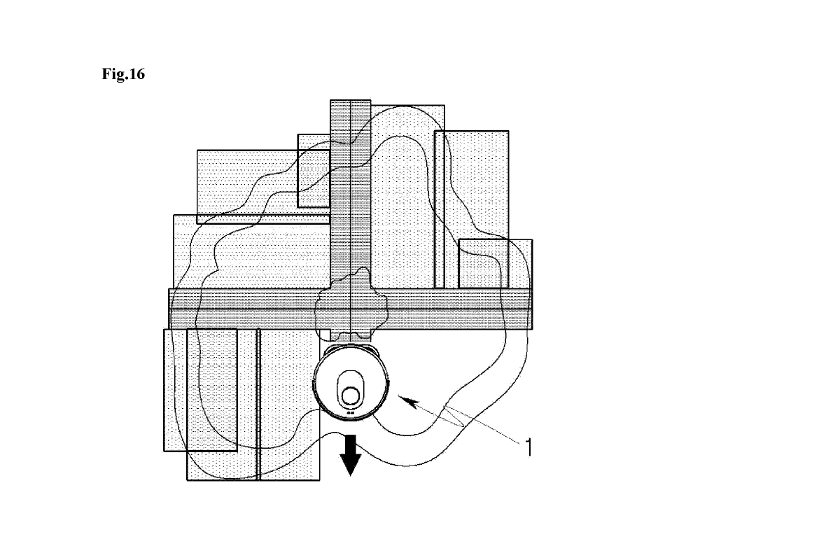

Alternatively, when the robot cleaner 1 is located at a starting point of a first reference traveling path R1, the robot cleaner 1 may travel backward along the first reference traveling path R1 (refer to FIG. 15).

In the backward cleaning step S310, the control unit 190 may operate the driving unit 160 and the wet cleaning unit 140.

Specifically, in the backward cleaning step S310, the control unit 190 may operate the driving motor 162 to move the robot cleaner 1 backward. That is, in the backward cleaning step S310, the robot cleaner 1 may travel backward through the cleaning area A. Accordingly, the pair of wheels 161 may be rotated to cause the robot cleaner 1 to move backward. Here, the term "backward" may mean moving in a direction opposite to the forward direction. Alternatively, the term "backward" may mean that a part of the robot cleaner 1 where the water tank 130 is disposed moves forward. Alternatively, the term "backward" may mean moving in a state where the rotary plate 141 is disposed closer to a target point than the wheel 161 in the robot cleaner 1. That is, the term "backward" may mean traveling in a state where the wet cleaning unit 140 is disposed closer to the target point than the driving unit 160.

In this case, in the backward cleaning step S310, the control unit 190 may operate the wet cleaning motor 143 to clean liquid present on the floor surface.

At this time, in the backward cleaning step S310, a rotation direction of the pair of rotary plates 141 may be opposite to the rotation direction of the pair of rotary plates 141 in the step of moving to the initial starting point (S230). That is, when viewed from a lower side of the robot cleaner 1, in the backward cleaning step S310, the left rotary plate 141a may rotate in a clockwise direction, and the right rotary plate 141b may rotate in a counterclockwise direction. Through this, while the robot cleaner 1 moves backward, the pair of rotary plates 141 may wipe while collecting foreign substances, such as liquid, toward an inner side of the robot cleaner 1.

Meanwhile, in the backward cleaning step S310, the control unit 190 does not operate the dry cleaning unit 150. This is to prevent an inside of the dust bin 120 from being contaminated with liquid when the liquid is sucked in, as a large amount of liquid has been spilled.

Through the backward cleaning step S310, the robot cleaner 1 may collect the liquid on the floor surface onto a reference traveling path RN.

In addition, when the robot cleaner 1 travels along the reference traveling paths R1, ... RN in the backward cleaning step S310, there is an effect of collecting the liquid on the floor surface toward the origin O within the cleaning area A.

In the forward traveling step S320, after the backward cleaning step S310, the robot cleaner 1 may move forward to return to a starting position of the immediately preceding backward cleaning step S310.

In the forward traveling step S320, the control unit 190 may cause the robot cleaner 1 to travel forward. Specifically, the control unit 190 may control the driving unit 160 to control the robot cleaner 1 to move forward. Accordingly, the pair of wheels 161 may be rotated to cause the robot cleaner 1 to move forward. Accordingly, the robot cleaner 1 may be moved to an outer edge of the cleaning area (refer to FIGS. 11 and 16).

In this case, the control unit 190 may not operate the wet cleaning unit 140 and the dry cleaning unit 150.

In addition, in the forward traveling step S320, the control unit 190 may detect the liquid on the floor surface B through the sensor unit 180. For example, in the forward traveling step S320, the lower camera sensor 184 may detect the liquid on the floor surface B to check whether the liquid on the floor surface has been wiped through the backward cleaning step S310.

In this case, if liquid still remains even though the floor surface has been wiped in the backward cleaning step S310, the control unit 190 may control the backward cleaning step S310 to be performed again.

When liquid does not remain on the floor surface cleaned in the backward cleaning step S310, the control unit 190 may perform the path switching step S330.

In the path switching step S330, after the forward traveling step S320, the robot cleaner 1 may travel backward to move to a starting point of a next traveling path or a reference traveling path.

When the forward traveling step S320 is completed, the robot cleaner 1 may be located at a starting point in the previous backward cleaning step S310. That is, the robot cleaner 1 may reach an outer edge of a region where the liquid exists.

In this case, the robot cleaner 1 may travel backward along a direction intersecting a direction in which the robot cleaner 1 traveled in the backward cleaning step S310 to move to the starting point of the next traveling path or the reference traveling path.

For example, when the robot cleaner 1 is located at a starting point of a first traveling path L11 of a first divided area A1 after performing the forward traveling step S320, the robot cleaner 1 may move backward to a starting point of a second traveling path L12 of the first divided area A1 (refer to FIG. 12).

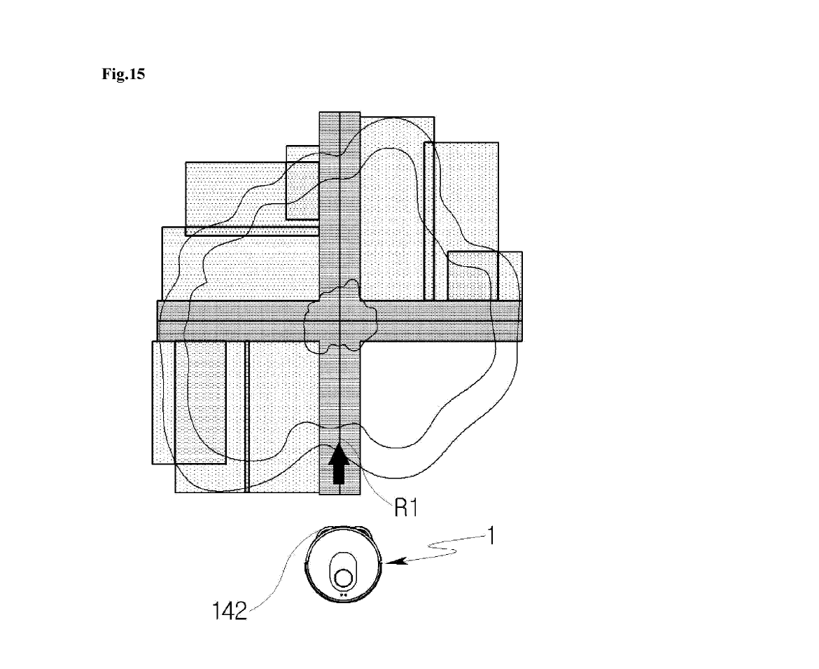

As another example, when the robot cleaner 1 is located at a starting point of a last traveling path L1N of the first divided area A1, the robot cleaner 1 may travel backward to a starting point of a first reference traveling path R1 (refer to FIG. 14).

As another example, when the robot cleaner 1 is located at the starting point of the first reference traveling path R1, the robot cleaner 1 may travel backward to a starting point of a first traveling path L21 of a second divided area A2.

In the path switching step S330, the control unit 190 may operate the driving unit 160 and the wet cleaning unit 140.

Specifically, in the path switching step S330, the control unit 190 may operate the driving motor 162 to move the robot cleaner 1 backward. That is, in the backward cleaning step S310, the robot cleaner 1 may travel backward through the cleaning area A. Accordingly, the pair of wheels 161 may be rotated to cause the robot cleaner 1 to move backward.

In this case, in the path switching step S330, the control unit 190 may operate the wet cleaning motor 143 to clean liquid present on the floor surface.

At this time, in the path switching step S330, a rotation direction of the pair of rotary plates 141 may be the same as the rotation direction of the pair of rotary plates 141 in the backward cleaning step S310. Through this, while the robot cleaner 1 moves backward, the pair of rotary plates 141 may wipe while collecting foreign substances, such as liquid, toward an inner side of the robot cleaner 1.

Meanwhile, in the path switching step S330, the control unit 190 does not operate the dry cleaning unit 150. This is to prevent an inside of the dust bin 120 from being contaminated with liquid when the liquid is sucked in, as a large amount of liquid has been spilled.

Accordingly, through the path switching step S330, the robot cleaner 1 may move to a starting point of a traveling path to be traveled next or a reference traveling path.

Subsequently, the control unit 190 may repeatedly perform the backward cleaning step S310, the forward traveling step S320, and the path switching step S330.

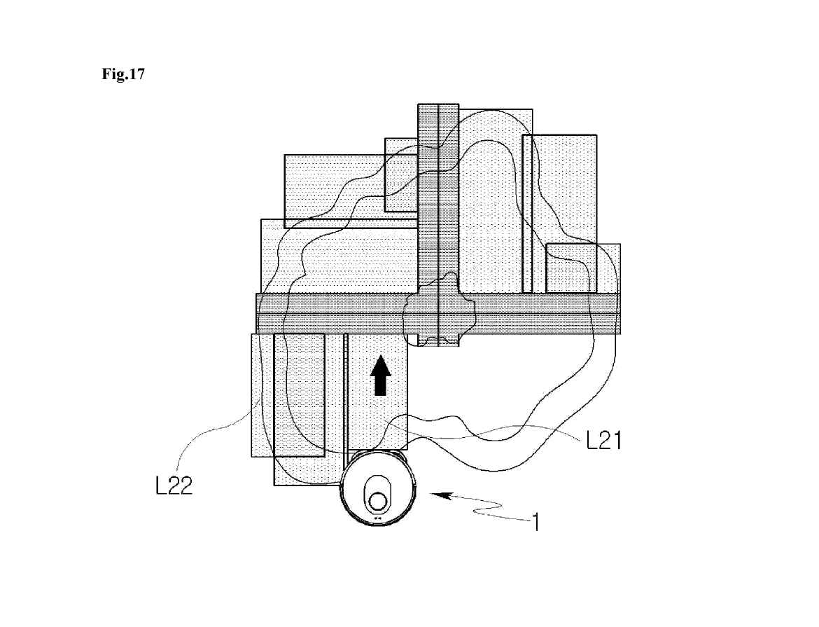

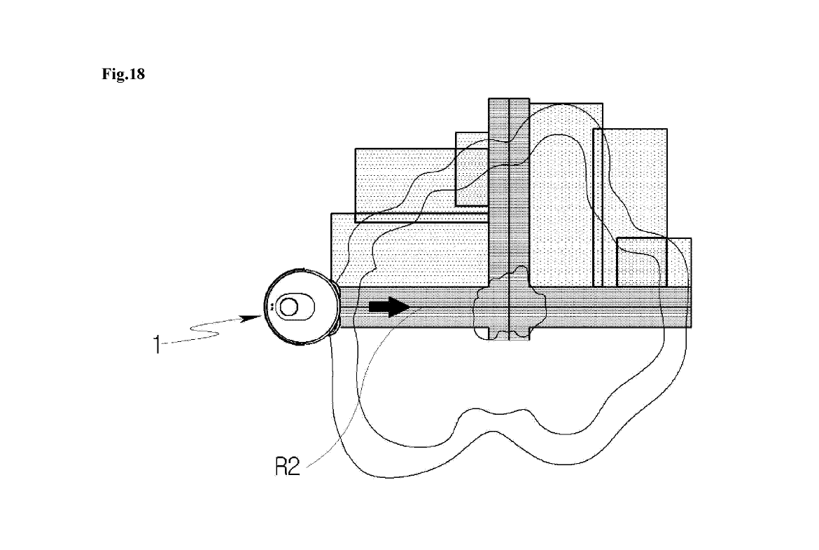

Through the cleaning step S300, the robot cleaner 1 may clean divided areas A1, A2, A3, and A4 in sequence (refer to FIGS. 17 to 20) by cleaning the traveling paths L11, ... L1N of the first divided area A1 in order and then cleaning the first reference traveling path R1 (refer to FIGS. 10 to 16).

Meanwhile, when the robot cleaner 1 arrives at a starting point of the initial reference traveling path R0 after the path switching step S330, the control method enters the cleaning termination step S400.

In the cleaning termination step S400, the robot cleaner 1 may travel backward along a fourth reference traveling path R4 to move to the origin O, and then terminate the cleaning.

Specifically, the control unit 190 may detect that the robot cleaner 1 has arrived at the starting point of the initial reference traveling path R0 through the sensor unit 180. In this case, the fourth reference traveling path R4 and the initial reference traveling path R0 may coincide with each other.

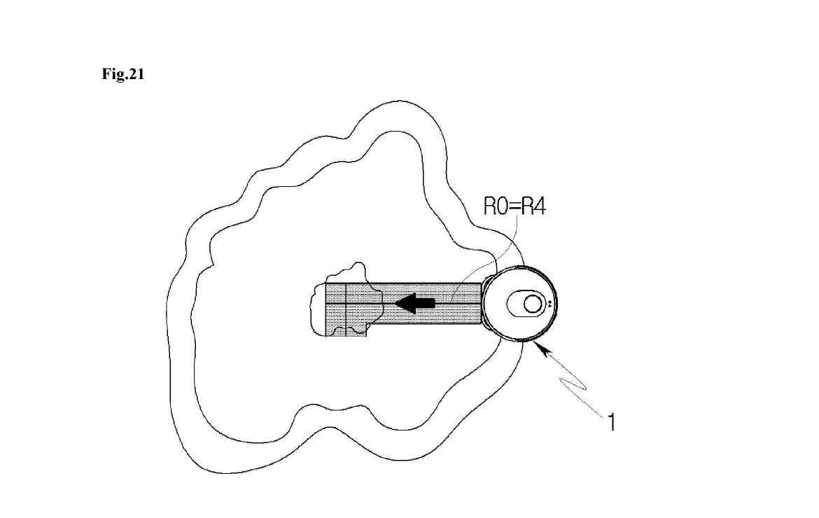

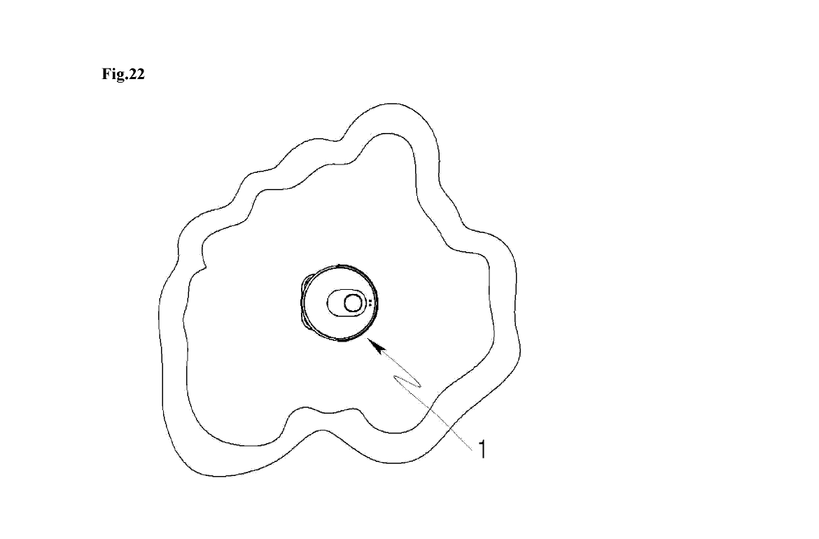

Accordingly, the control unit 190 may clean the floor surface while traveling backward along the fourth reference traveling path R4. In this case, the robot cleaner 1 may travel in the same manner as in the backward cleaning step S310. That is, the control unit 190 may operate the driving unit 160 and the wet cleaning unit 140 (refer to FIG. 21).

Subsequently, when the robot cleaner 1 arrives at the origin O of the cleaning area, the traveling may be terminated. Through this, the robot cleaner 1 may collect the liquid on the cleaning area toward the origin O. Then, the mop 142 may be placed on the origin O so that the mop 142 can absorb the liquid as much as possible. In addition, since the robot cleaner 1 covers an upper side of the liquid, there is an effect of visually notifying a user of a position where the liquid is present. Through this, there is an effect of indicating so that the user can additionally wipe off the liquid if necessary (refer to FIG. 22).

Although the present disclosure has been described in detail through specific embodiments, these are for describing the present disclosure in detail, and the present disclosure is not limited thereto. It is apparent that modifications or improvements can be made by those skilled in the art within the technical spirit of the present disclosure.

All simple modifications or changes of the present disclosure fall within the scope of the present disclosure, and the specific scope of protection of the present disclosure will be made clear by the appended claims.

### DESCRIPTION OF REFERENCE NUMERALS

1: Robot cleaner

110: Body

120: Dust bin

130: Water tank

140: Wet cleaning unit

150: Dry cleaning unit

160: Driving unit

180: Sensor unit

190: Control unit

What is claimed is:

1. A robot cleaner, comprising:
a body accommodating a battery and at least one motor therein, the body having a suction port formed therein;
a driving unit configured to move the body; and
a wet cleaning unit configured to wipe a floor surface,
wherein, when liquid is present on the floor surface, the body is configured to travel backward toward a position where the liquid is present in a state where the wet cleaning unit is disposed closer to the position of the liquid than the suction port.

2. The robot cleaner of claim 1, wherein the body is configured to travel forward away from the position where the liquid is present in a state where the suction port is disposed closer to the position of the liquid than the wet cleaning unit.

3. The robot cleaner of claim 2, wherein the body is configured to repeatedly travel backward and forward side by side at preset intervals with respect to the position where the liquid is present.

4. The robot cleaner of claim 1, wherein the body is configured to travel along a first direction, and when the body reaches an outer edge of a region where the liquid is present, the body is configured to travel through the position where the liquid is present along a second direction perpendicular to the first direction.

5. The robot cleaner of claim 1, wherein the body is configured to start backward traveling from a plurality of points centered on the position where the liquid is present.

6. The robot cleaner of claim 1, wherein the wet cleaning unit comprises a pair of mops configured to wipe the floor surface by rotation,
wherein a rotation direction of the mops when wiping the floor surface while moving backward is opposite to a rotation direction of the mops when wiping the floor surface while moving forward.

7. A control method of a robot cleaner, the method comprising:
a zone setting step of detecting liquid on a floor surface and setting a zone in a region where the liquid is present; and
a cleaning step of cleaning the region where the liquid is present while traveling therethrough,
wherein the cleaning step comprises:
a backward cleaning step of traveling through the region where the liquid is present in a direction opposite to a traveling direction in the zone setting step.

8. The method of claim 7, wherein the cleaning step further comprises:
a forward traveling step of traveling in the same direction as the traveling direction in the zone setting step after the backward cleaning step.

9. The method of claim 7, wherein, in the cleaning step, when the robot cleaner reaches an outer edge of the region where the liquid is present, the robot cleaner travels through the region where the liquid is present by moving backward along a direction intersecting a direction in which the robot cleaner traveled in the backward cleaning step.

10. The method of claim 7, wherein the setting of the zone comprises:
setting an origin within the region where the liquid is present; and
setting a plurality of divided areas along a circumferential direction around the origin.

11. The method of claim 10, wherein the setting of the zone comprises dividing the region where the liquid is present based on the origin.

12. The method of claim 10, wherein the cleaning comprises collecting the liquid toward the origin.
